(19) United States
(12) Patent Application Publication
(10) Pub. No.: US 2013/0050103 A1
(43) Pub. Date: Feb. 28, 2013

(54) DISPLAY DEVICE INCLUDING TOUCH PANEL

(71) Applicants: Ha Yoon Song, Gyunggi-do (KR); Young Jae Kim, Gyunggi-do (KR); Ho Joon Park, Seoul (KR)

(72) Inventors: Ha Yoon Song, Gyunggi-do (KR); Young Jae Kim, Gyunggi-do (KR); Ho Joon Park, Seoul (KR)

(73) Assignee: SAMSUNG ELECTRO-MECHANICS CO., LTD., Gyunggi-do (KR)

(21) Appl. No.: 13/312,763

(22) Filed: Dec. 6, 2011

(30) Foreign Application Priority Data
Aug. 25, 2011 (KR) 1020110085223

(51) Int. Cl. G06F 3/041

(52) U.S. Cl. 345/173

(57) ABSTRACT

Disclosed herein is a display device including a touch panel, including: a touch panel having a transparent substrate and a sensing electrode formed on the transparent substrate; and a display unit combined with one surface of the touch panel, wherein the touch panel and the display unit are attached to each other by a UV resin layer. According to the present invention, conductive balls are contained in the UV resin layer, whereby noise that may be generated from the display unit can be shielded.

### CROSS REFERENCE TO RELATED APPLICATION

This application claims the benefit of Korean Patent Application No. 10-2011-0085223, filed on Aug. 25, 2011, entitled “Display Including Touch Panel”, which is hereby incorporated by reference in its entirety into this application.

### BACKGROUND OF THE INVENTION

1. Technical Field

The present invention relates to a display device including a touch panel.

2. Description of the Related Art

With the development of computers using digital technology, computer assisted devices have also been developed together, and personal computers, portable transmission devices, other personal information processing apparatus, or the like perform text and graphic processes using various input devices, such as a keyboard or a mouse. While the rapid advancement of an information-oriented society has been widening the use of computers more and more, there have been occurring the problems of it being difficult to efficiently operate products using only the keyboard and mouse as being currently responsible for the input device function. Thus, the demand for a device that is simple, has minimal malfunction, and has the capability to easily input information is increasing.

Furthermore, current techniques for input devices exceed the level of fulfilling general functions and thus are progressing towards techniques related to high reliability, durability, innovation, designing and manufacturing. To achieve this purpose, a touch screen has been developed as an input device capable of inputting information such as text and graphics.

The touch screen is mounted on the display surface of an image display device such as an electronic organizer, a flat panel display including a liquid crystal display (LCD), a plasma display panel (PDP), an electroluminescence (El) device or the like, or a cathode ray tube (CRT), so that a user selects the information desired while viewing the image display device.

The touch screen can be classified into a resistive type, a capacitive type, an electromagnetic type, a surface acoustic wave (SAW) type, and an infrared type. The type of touch screen selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch screen. In particular, resistive and capacitive types are prevalently used at the present time.

Particularly, in cases where the capacitive type touch screen is coupled with a display unit such as a liquid crystal display (LCD), touch sensitivity is deteriorated due to various noise generated from the display unit. Furthermore, in cases where a separate noise shielding layer is formed, processes need to be added and a thin type touch screen is difficult to be manufactured.

### SUMMARY OF THE INVENTION

The present invention has been made in an effort to provide a display device including a touch panel capable of attaching the touch panel and a display unit and removing noise, by using UV resin containing conductive balls when the touch panel and the display unit are attached to each other.

According to a preferred embodiment of the present invention, there is provided a display device including a touch panel, including: a touch panel having a transparent substrate and a sensing electrode formed on the transparent substrate; and a display unit combined with one surface of the touch panel, wherein the touch panel and the display unit are attached to each other by a UV resin layer.

The UV resin layer may contain conductive balls.

The conductive ball may have a diameter of 3 gill to 10M.

The display device may further include ground layers formed at both ends of the UV resin layer.

The sensing electrode formed on the transparent substrate may be a transparent electrode.

The sensing electrode formed on the transparent substrate may be a metal mesh electrode.

According to another preferred embodiment of the present invention, there is provided a display device including a touch panel, including: a touch panel including: a first sensing electrode sensing a variation in capacitance; an insulating layer formed on one surface of the first sensing electrode; a second sensing electrode formed on the insulating layer; and a window formed on the second sensing electrode; a UV resin layer formed on the other surface of the first sensing electrode of the touch panel; and a display unit attached to the UV resin layer.

The UV resin layer may contain conductive balls.

The conductive ball may have a diameter of 3 μm to 10 μm.

The display device may further include ground layers formed at both ends of the UV resin layer.

The first or second sensing electrode may be a transparent electrode.

The first or second sensing electrode may be a metal mesh electrode.

### BRIEF DESCRIPTION OF THE DRAWINGS

FIG. 1 shows a display device including a touch panel according to the present invention;

FIG. 2 shows a real configuration of a UV resin layer containing conductive balls of the present invention;

FIG. 3 is a cross-sectional view of the conductive ball according to the present invention; and

FIG. 4 shows a display device including a touch panel according to another preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, “one surface”, “the other surface”, and so on are used to distinguish one element from another element, and the elements are not defined by the above terms. Further, in describing the present invention, a detailed description of related known functions or configurations will be omitted so as not to obscure the gist of the present invention.

Hereafter, preferred embodiments of the present invention will be described in detail with reference to the accompanying drawings.

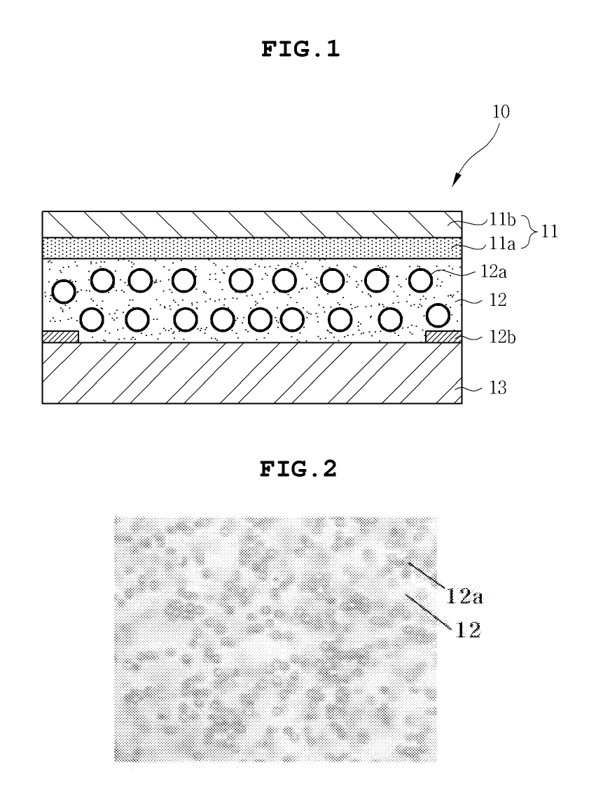

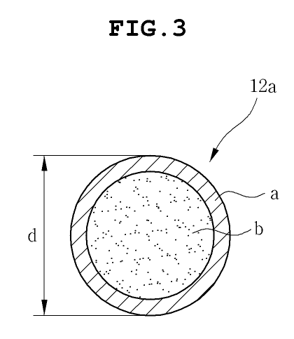

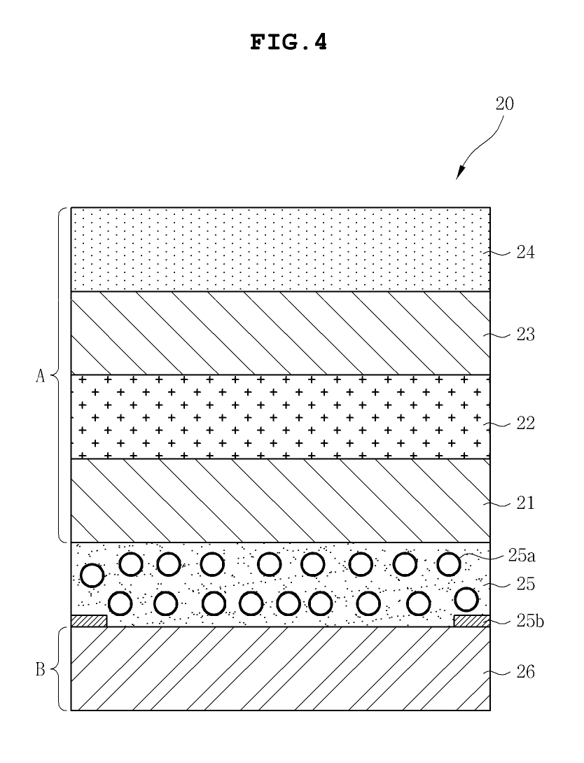

FIG. 1 shows a display device including a touch panel according to the present invention; FIG. 2 shows a real configuration of a UV resin layer containing conductive balls of the present invention; FIG. 3 is a cross-sectional view of the conductive ball according to the present invention; and FIG. 4 shows a display device including a touch panel according to another preferred embodiment of the present invention.

A display device including a touch panel according to the present invention, as shown in FIG. 1, includes a touch panel 11 having a transparent substrate 11a and a sensing electrode 11b formed on the transparent substrate, and a display unit 13 combined with one surface of the touch panel 11. The touch panel 11 and the display unit 13 are attached to each other by a UV resin layer 12.

A material for the transparent substrate 11a is not particularly limited, as long as it has a predetermined level of hardness or more, but the transparent substrate 11a is preferably formed of polyethylene terephthalate (PET), polycarbonate (PC), polymethylmethacrylate (PMMA), polyethylene naphthalate (PEN), polyether sulfone (PES), cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, tempered glass, or the like. In addition, since a transparent electrode is formed on one surface of the transparent substrate 11a, a high frequency treatment, a primer treatment or the like may be performed on one surface of the transparent substrate 11a in order to improve adhesive strength between the transparent substrate 11a and the transparent electrode, thereby forming a surface treatment layer.

As the sensing electrode 11b, a transparent electrode or a metal mesh electrode may be used. The transparent electrode functions to generate signals at the time of a user touch so as to allow a controller (not shown) to recognize coordinates thereof. The transparent electrode is formed on one surface of the transparent substrate 11a. Here, the transparent electrode may be formed of a conductive polymer, and specifically, poly-3,4-ethylenedioxythiophene/polystyrenesulfonate (PEDOT/PSS), polyaniline, polyacetylene, polyphenylenevinylene, or the like. Besides, indium tin oxide (ITO), an organic transparent electrode material, such as carbon nanotube, graphene, ZnO (zinc oxide), or SnO₂ (tin oxide), or the like, may be used, and it is obvious to those skilled in the art that various materials for the transparent electrode may be selected or altered. The transparent electrode may be formed on the transparent substrate 11a by a physical method, such as a sputtering method, a vacuum deposition method, an ion plating method, or the like, or a chemical method, such as a spray method, a dip method, a chemical vapor deposition (CVD) method, or the like, but is not limited thereto.

The metal mesh electrode may be formed by spinning a spinning solution on the transparent substrate 11a through electrospinning. The spinning solution is prepared by dispersing metal, metal oxide, conductive polymer, carbon nanotube, graphene, or a combination thereof, together with a binder, in a solvent. Specifically, examples of the metal may include copper (Cu), aluminum (Al), gold (Au), silver (Ag), titanium (Ti), palladium (Pd), chrome (Cr), and a combination thereof, and examples of the metal oxide may include indium tin oxide (ITO), antimony tin oxide (ATO), aluminum zinc oxide (AZO), and a combination thereof. The conductive polymer may include the above-exemplified materials. Since the other matter in respect to the method of forming the metal mesh electrode by the electrospinning method are general, detailed descriptions thereof will be omitted. The metal mesh electrode may also be formed by various methods other than the electrospinning method. Descriptions about the known methods will be omitted.

The display unit 13 is combined with one surface of the touch panel 11. The display unit 13 functions to visually output data on a screen. The display unit 13 may consist of a cathode ray tube (CRT), a liquid crystal display (LCD), a plasma display panel (PDP), a light emitting diode (LED), an organic light emitting diode (OLED), or the like, but is not limited thereto.

The UV resin layer 12 functions to attach the touch panel 11 and the display unit 13 to each other. The UV resin layer 12 may be a UV hardenable resin, and is a resin in which a liquid type UV hardenable resin raw material is subjected to ultraviolet rays to become a solid type polymer. Specifically, a resin in which monomers or oligomers become a polymer through a reaction initiated by a reaction initiator when ultraviolet rays emitted from the UV lamp are radiated, a UV adhesive having photosensitivity, a resin for UV coating, a UV ink, or the like, is instantly hardened by photopolymerization. In cases where the UV resin is used, the hardening time is short, for example, within several seconds, thereby improving productivity, and the equipment is compact, thereby making working task practicable even in the narrow space. In addition, the UV resin layer has high hardness, high reinforcement performance, high sensitivity, solvent-resistant property, chemical-resistant property, fouling-resistant property, rub-resistant property, and the like. In the present invention, the UV resin layer 12 functions as an adhesive for attaching the touch panel 11 and the display unit B, and at the same time, it contains conductive balls 12a so that various noise generated from the display unit 13 can be shielded.

As shown in FIGS. 2 and 3, the conductive ball 12a may be formed of carbon fiber, metal (Ni, solder), metal (Ni, Au)-coated polymer, or the like. Among them, the conductive ball 12a made of the metal-coated polymer may be used. The conductive ball 12a may consist of the metal-coated polymer. The conductive ball 12a may be formed by forming a polymer spacer core at part a of the conductive ball 12a, and sequentially coating nickel (Ni) and gold (Au) at part b of the conductive ball 12a, as shown in FIG. 3.

The conductive ball 12a is preferably transparent, but may be coated with a conductive metal, thereby exhibiting opaque property. However, even though the conductive ball 12a is not completely transparent, the entire transmittance of the conductive ball 12a is not significantly affected since size and density of the conductive ball 12a present on the transparent electrode are not so large.

In particular, the conductive ball 12a of the present invention is preferably formed to have a diameter d of 3 μm to 10 μm (see, FIG. 3). If the diameter d of the conductive ball 12a is below 3 μm, the conductive ball 12a is too small, such that the capability of the UV resin layer to shield noise generated from the display unit 13 is reduced when the conductive balls are contained in the UV resin layer 12. If the diameter d of the conductive ball 12a is above 10 μm, the conductive ball 12a contained in the UV resin layer 12 is too large, so that there may occur an electric short circuit between the conductive balls 12a or electric problems due to other external stimulation, with the result that the touch panel 11 may be erroneously operated. Therefore, the conductive balls 12a having a diameter within the above range are contained in the UV resin layer 12, and thus, the UV resin layer 12 can preferably perform a function of shielding noise from the display unit 13.

Ground layers 12b are formed for ground connection against an electric short circuit due to the conductive balls 12a, and are preferably formed at both ends on a surface between which the UV resin layer 12 and the display unit 13 are attached.

A display device including a touch panel according to another preferred embodiment of the present invention, includes a touch panel A including a first sensing electrode 21 sensing a variation in capacitance, an insulating layer 22 formed on one surface of the first sensing electrode 21, a second sensing electrode 23 formed on the insulating layer 22, and a window 24 formed on the second sensing electrode 23; a UV resin layer 25 formed on the other surface of the first sensing electrode of the touch panel A; and a display unit 26 or B attached to the UV resin layer 25.

The descriptions about the first sensing electrode 21 and the second sensing electrode 23 are the same as that of the above sensing electrode 11b, and thus, detailed descriptions thereof will be omitted.

The first sensing electrode 21 and the second sensing electrode 23 may be formed by using a transparent electrode or a metal mesh electrode. The first sensing electrode 21 and the second sensing electrode 23 function to generate signals at the time of a user touch so as to allow a controller (not shown) to recognize coordinates thereof. The present preferred embodiment is characterized in that the first sensing electrode 21 is formed on the insulating layer 22, and the second sensing electrode 23 is formed on the window 24.

The insulating layer 22 formed on one surface of the first sensing electrode 21 is preferably a transparent insulating layer 22. The transparent insulating layer 22 is, for example, a transparent substrate, and may be formed by using a transparent inorganic material, such as, glass, silicon oxide, and the like, or a transparent organic material, such as, an acryl resin, a silicon resin, a polyethylene terephthalate resin, a polyvinylidene resin, a polycarbonate resin, a cyclic olefin resin, and the like.

The touch panel A and the display unit B or 26 are attached to each other by the UV resin layer 25, and the conductive balls 25a contained within the UV resin layer 25 can shield noise which may be generated from the display unit B or 26. Ground layers 25b are further formed at both ends of the UV resin layer 25 to shield noise and maintain electric stability. Since other related descriptions overlap the display device including the touch panel according to the above one preferred embodiment of the present invention, detailed descriptions thereof will be omitted.

The window 24 is disposed at the outermost region, and formed on one surface of the second sensing electrode 23. The window 24 also functions as a protective layer for protecting the second sensing electrode 23. The window 24 may be formed of an acryl resin (polymethylmethacrylate, PMMA), glass, or polycarbonate, but not limited thereto. Any material that can have appropriate hardness and appropriate insulating property may be used for the window 24.

According to the present invention, the touch panel and the display unit are attached to each other by the UV resin layer, thereby simplifying the process and accurately performing attaching alignment.

Further, the conductive balls are contained in the UV resin layer, thereby shielding noise generated from the display unit.

Further, the UV resin layer shields noise that may be generated from the display unit, thereby improving operating reliability and operating performance of the touch panel.

Although the preferred embodiments of the present invention have been disclosed for illustrative purposes, they are for specifically explaining the present invention and thus a display device including a touch panel according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A display device including a touch panel, comprising:
a touch panel having a transparent substrate and a sensing electrode formed on the transparent substrate; and
a display unit combined with one surface of the touch panel,
wherein the touch panel and the display unit are attached to each other by a UV resin layer.

2. The display device as set forth in claim 1, wherein the UV resin layer contains conductive balls.

3. The display device as set forth in claim 1, wherein the conductive ball has a diameter of 3 μm to 10 μm.

4. The display device as set forth in claim 2, further comprising ground layers formed at both ends of the UV resin layer.

5. The display device as set forth in claim 1, wherein the sensing electrode formed on the transparent substrate is a transparent electrode.

6. The display device as set forth in claim 1, wherein the sensing electrode formed on the transparent substrate is a metal mesh electrode.

7. A display device including a touch panel, comprising:
a touch panel including: a first sensing electrode sensing a variation in capacitance; an insulating layer formed on one surface of the first sensing electrode; a second sensing electrode formed on the insulating layer; and a window formed on the second sensing electrode;
a UV resin layer formed on the other surface of the first sensing electrode of the touch panel; and
a display unit attached to the UV resin layer.

8. The display device as set forth in claim 7, wherein the UV resin layer contains conductive balls.

9. The display device as set forth in claim 8, wherein the conductive ball has a diameter of 3 μm to 10 μm.

10. The display device as set forth in claim 7, further comprising ground layers formed at both ends of the UV resin layer.

11. The display device as set forth in claim 7, wherein the first or second sensing electrode is a transparent electrode.

12. The display device as set forth in claim 7, wherein the first or second sensing electrode is a metal mesh electrode.
